(19) United States
(12) Patent Application Publication
(10) Pub. No.: US 2014/0156544 A1
(43) Pub. Date: Jun. 5, 2014

(54) Non-Tangible Assets Valuation Tool

(71) Applicants: Matteo Sabattini, Philadelphia, PA (US); Vinh Do, East Walpole, MA (US)

(72) Inventors: Matteo Sabattini, Philadelphia, PA (US); Vinh Do, East Walpole, MA (US)

(21) Appl. No.: 14/092,985

(22) Filed: Nov. 28, 2013

Related U.S. Application Data
(60) Provisional application No. 61/731,483, filed on Nov. 30, 2012.

(51) Int. Cl. G06Q 50/18; G06Q 10/00

(52) U.S. Cl. CPC G06Q 50/184; G06Q 10/00
USPC 705/310

(57) ABSTRACT

An analytical tool for valuating non-tangible assets, including, but not limited to, patents, patent applications, invention disclosures, etc., based on an analysis of attributes of, and logical connections between, said non-tangible assets.

### CROSS-REFERENCE TO RELATED APPLICATIONS

This application claims priority to U.S. Provisional Application No. 61/731,483, filed Nov. 30, 2012, which is herein incorporated by reference in its entirety for all purposes.

### REFERENCES

U.S. Pat. No. 6,061,662
U.S. Pat. No. 6,173,276
U.S. Pat. No. 6,389,418
U.S. Pat. No. 6,546,375
U.S. Pat. No. 6,556,992
U.S. Pat. No. 7,606,757
U.S. Pat. No. 7,657,476
U.S. Pat. No. 7,716,226
U.S. Pat. No. 7,949,581
U.S. Pat. No. 7,962,511
U.S. Pat. No. 8,131,701
U.S. Pat. No. 8,145,639
U.S. Pat. No. 8,145,640
U.S. Pat. No. 8,161,049
U.S. Pat. No. 8,326,851
U.S. Pat. No. 8,504,560
US 2003/0212572
US 2005/0261927
US 2011/0161089

### FIELD OF THE INVENTION

The present invention involves analytics and valuation of non-tangible assets. More particularly, the present invention is in the technical field of statistical and attribute-based non-tangible assets analytics and valuation.

### BACKGROUND OF THE INVENTION

In today's economy, intellectual property (IP) and non-tangible assets have gained a lot of attention as a complementary revenue source for corporations, and an investment opportunity for businesses and investors. While most investors and professionals recognize the value of IP as a whole, the actual value of a specific asset or portfolio is hard to grasp and quantify.

Computer-based models to determine the value, monetary or otherwise, of financial assets and commodities are well known in the art. See for example U.S. Pat. Nos. 6,546,375, 6,173,276, 6,061,662.

Similar to financial assets like stocks, patents have become valuable assets for companies and investors, and a vibrant market has developed for the sale, acquisition and licensing of patents. At the same time, the IP marketplace has developed into a very litigious environment, where the number of patent infringement lawsuits has exploded, and patents of doubtful quality and strength are often used as a weapon. The cost of these “patent wars” is ultimately passed to the consumers, resulting in a less-than-efficient market. Conventional methods to value non-tangible assets, such as patents, often rely on the technical analysis of the asset itself by an expert in the field of the invention. Such analysis is often time and resource intensive, relies on technical experts that have knowledge of one, and only one, specific technical field, and is, therefore, not easily scalable.

Other conventional methods and apparatuses to value non-tangible assets base the commercial value of said assets on non-relevant or loosely relevant characteristics associated with the asset itself, failing to provide a method or an apparatus to associate relevant characteristics based on other non-tangible assets pertaining to similar technical fields or being somewhat related to the asset itself.

A few methods of patents evaluation have been proposed recently as will be discussed below. Many of them are based on the idea of collecting suitable information about a patent under evaluation and transforming it into a monetary value of the patent. Unfortunately, most of the proposed methods of patent evaluation fail at the very beginning of the evaluation process when deciding on a set of parameters to characterize a patent and its quality or value. In addition, methods in the prior art fail to exploit interrelationships between different patents, like citations, and the contribution of such interrelationships to the quality or value of said patents.

Consider, for example, U.S. Pat. No. 7,657,476, a selected patent value estimating method for valuing patent asset, involves functionally correlating expected value for selected patent to score for patent, and converting expected value to non-currency-denominated scale.

Further consider U.S. Pat. No. 8,145,639, a patent document evaluating method, involves combining patent indices into patent quality index to characterize value of document upon non-linear function that is monotonous and bounded on interval of variation in indices; U.S. Pat. No. 8,145,640, a patent document evaluating method, involves combining patent indices into patent quality index according to non-linear scale, and visualizing value of patent document using color coding of document based on value of quality index; and U.S. Pat. No. 8,161,049, a patent document evaluating method for use in industrial progress, involves analyzing values of patent indices by artificial intelligence system by generating conclusion regarding value of patent document based on analysis.

Another example are U.S. Pat. No. 6,556,992, a statistical patent rating method for valuations, involves constructing computer regression model based on patent metrics selected corresponding to prevalent characteristics provided in both population of patents; and U.S. Pat. No. 7,962,511, an estimation of probability of future event for intellectual property assets, involves constructing model or algorithm using metrics identifying/quantifying characteristics of intellectual property assets for which event has/has not occurred.

A further attempt to solve some of the above-mentioned problems is U.S. Pat. No. 7,606,757, a computer implemented method of computing estimate value of patent of patent portfolio, involves computing patent weight index for patent by aggregating matrix elements associated with patents at sub period.

In yet another attempt, U.S. Pat. No. 7,949,581, patent/technology's estimated depreciation schedule constructing method involves constructing estimated depreciation schedule using calculated decay coefficient.

Further consider U.S. Pat. No. 6,389,418, a data mining method in patent database, involves assigning coordinates to each patent in two-dimensional space, such that distance between two patents represents relationship between two patents.

Similarly, US patent application 2011/0161089, a method for valuating patent using citation network that is utilized by users, involves calculating multiple centrality indices with respect to patent cases in cluster.

In yet another example, U.S. Pat. No. 8,131,701, a computer-implemented method for probabilistically quantifying degree of relevance between related data objects, involves applying probability transform function to determined generational citation count to determine relevance score.

Another example is U.S. Pat. No. 8,326,851, a computer system searches, retrieves and stores information, regarding intellectual property within technology exchange in and from respective databases for valuing and modeling of intellectual property according to user.

Further consider U.S. Pat. No. 8,504,560, a computer-implemented method for probabilistically quantifying degree of relevance between citationally or contextually related data objects, involves storing data value in computer storage in association with identifiers of documents; and U.S. Pat. No. 7,716,226, a relevance measuring method, involves measuring number and type of relevance links between two or more data objects of interest, and applying probability transform function to probabilistically determine event probability.

Another example is US patent application 2005/0261927, an intellectual property collection valuing method, involves estimating amount of party's revenue to which intellectual property collection is deemed to apply, and placing value on collection based on revenue and information.

Accordingly, there is a need in the industry for the development of a method and system for systematic evaluation of non-tangible assets, which would be more reliable, provide more consistent and meaningful results, determine relationships between assets and portfolios, and consequently, would be suitable for the analysis and valuation of patent portfolios.

### SUMMARY OF THE INVENTION

Therefore it is an object of the invention to provide an improved method and system for valuation of non-tangible assets, which would avoid the above-mentioned problems, while providing more consistent results and being suitable for the analysis and valuation of large portfolios of non-tangible assets.

The present invention provides a method and a system for identifying and valuating non-tangible assets, including, without limitation, at least one of the following: a patent, a patent application, a copyrightable work or product, a trade secret, a deliverable, a published paper or technical report, or an invention disclosure. Said method and system are based on an analysis of attributes of said non-tangible assets and logical connections between said non-tangible assets.

### BRIEF DESCRIPTION OF THE DRAWINGS

FIG. 1 is a graphical representation of a list of intellectual property parameters associated with at least one non-tangible asset according to one embodiment of the present invention;

FIG. 2 is a schematic representation of a network of non-tangible assets logically connected to at least one non-tangible asset of interest according to another embodiment of the present invention;

FIG. 3 is a schematic representation of a network of non-tangible assets logically connected to at least one non-tangible asset of interest according to yet another embodiment of the present invention;

FIG. 4a is a schematic representation of a set of seed non-tangible assets according to yet another embodiment of the present invention;

FIG. 4b is a schematic representation of a set of seed non-tangible assets according to yet another embodiment of the present invention;

FIG. 5 is a graphical representation of a multi-dimensional numerical score generated according to yet another embodiment of the present invention;

FIG. 6 is a graphical illustration of a marginal numerical score generated according to yet another embodiment of the present invention; and

FIG. 7 is a system view of a computer apparatus to evaluate the numerical score of a non-tangible asset according to yet another embodiment of the present invention.

### DETAILED DESCRIPTION OF THE INVENTION

In broad embodiment, the present invention is a method and apparatus for valuating non-tangible assets.

The term “non-tangible asset” means an asset other than a financial asset that lacks physical substance. Non-tangible assets can include, without limitation, patents, patent applications, copyrights, trade secrets, deliverables, published papers or technical reports, and invention disclosures.

The term “value” as used herein means intrinsic worth of the non-tangible asset, and includes, without limitation: monetary worth, technical strength, licensing potential, breadth of applicability, present or future infringement potential, strategic merit.

The term “time in prosecution” means the length of time between filing a patent application until a Notice of Allowance is issued.

The term intellectual property parameter means any identifiable metric of a non-tangible asset. Intellectual property parameters can include, without limitation, the number of other non-tangible assets by the same inventor(s), number of inventors of said at least one non-tangible asset, number of other non-tangible assets by the same assignee, number of assignments of said at least one non-tangible asset, number of claims of said at least one non-tangible asset, number of independent claims of said at least one non-tangible asset, number of dependent claims of said at least one non-tangible asset, number of words in a claim, number of keywords in a claim, number of family members of said at least one non-tangible asset, number of foreign counterparts of said at least one non-tangible asset, number of continuations, divisionals, or continuations-in-part of said at least one non-tangible asset, time in prosecution of said at least one non-tangible asset, time to expiration of said at least one non-tangible asset, maintenance status, number of citations of said at least one non-tangible asset, number of other non-tangible assets cited by said at least one non-tangible asset, number of other non-tangible assets cited by the examiner of said at least one non-tangible asset, number of other non-tangible assets cited by the inventor of said at least one non-tangible asset, number of other non-tangible assets that cite said at least one non-tangible asset, number of other non-tangible assets sharing the same patent class with said at least one non-tangible asset, number of other non-tangible assets sharing similar keywords with said at least one non-tangible asset, number of other non-tangible assets in a similar technical field to said at least one non-tangible asset.

The term “number of litigations” is a numerical value representing how often the non-tangible asset has been involved in adversarial disputes, as would be known to one of ordinary skill in the art. Number of litigations can include, with limitation, number of times a non-tangible asset has been asserted against any third party, number of district court litigations, number of litigations at the International Trade Commission (ITC), number of times the patent owner has obtained judgment by the courts, ratio of litigations asserted versus number of times cases settled voluntarily.

The term “portfolio” means a subset of items, wherein said items include, without limitation, non-tangible assets.

The term “to rank”, as would be known to one of ordinary skill in the art, means, without limitation, to sort non-tangible assets in decreasing order of their numerical scores, to sort non-tangible assets in increasing order of their numerical scores, to sort portfolios of non-tangible assets in decreasing order of their numerical scores, to sort portfolios of non-tangible assets in increasing order of their numerical scores,

The term “standard-essential patent”, means a patent that claims an invention that must be used to comply with a technical standard. For example, standard-essential patents include patents or patent applications that have been declared essential for the practice or implementation of a technical standard developed by standard setting organizations (SSOs) like the European Telecommunications Standards Institute (ETSI) or the Institute of Electrical and Electronic Engineers (IEEE).

The terms “logically connected” or logical connection mean an identifiable attribute link between two or more non-tangle assets. Logical connections include between non-tangible assets include, without limitation, citations to, or by, other non-tangible assets, non-tangible assets which share at least one common inventor, non-tangible assets which share the same assignee of at least one non-tangible asset, non-tangible assets included in the same patent technology classification subset, non-tangible assets included in the same technical field, non-tangible assets which share the same priority year.

The term “seed non-tangible asset” means a non-tangible asset which is predetermined to contain known value and used to establish a reference point from which the value of other non-tangible assets are evaluated. Seed non-tangible assets include, without limitation, non-tangible asset with known numerical score, non-tangible asset for which numerical scores have been previously calculated, non-tangible asset for which the value is known a-priori.

The term “marginal numerical score” means, without limitation, the difference of two numerical scores calculated at different instants in time.

The term “iteratively” means, without limitation, repeating an algorithm or specific step of an algorithm using as inputs at least one of the outputs generated by said algorithm at a previous instant in time.

The term “weight” means a number associated with an intellectual property parameter representing the relative importance of an intellectual property parameter to other intellectual property parameters.

The term “heuristic statistical algorithm based on probabilities” includes, without limitation, linear regression algorithm, statistical analysis, probabilistic numerical score calculation based on numerical scores of other non-tangible assets, Markov-chain-based algorithm, time-series analysis.

The term “multi-dimensional numerical score space” means two or more numerical scores calculated with different algorithms.

The term “observation”, as used herein means the analysis of a non-tangible asset using user-defined criteria to reach a determination on one or more attributes of the non-tangible asset. Observations include, without limitation detailed analysis of at least one non-tangible asset to determine the value of said at least one non-tangible asset, detailed analysis of at least one non-tangible asset to determine the numerical score of said at least one non-tangible asset wherein said numerical score indicates the relative value of said at least one non-tangible asset in relation to other non-tangible assets, detailed analysis of at least one non-tangible asset to determine intellectual property parameters associated with said at least one non-tangible asset, detailed analysis of at least one portfolio of non-tangible assets to determine the value of said at least one portfolio of non-tangible assets, detailed analysis of at least one portfolio of non-tangible assets to determine the numerical score of said at least one portfolio of non-tangible assets wherein said numerical score indicates the relative value of said at least one portfolio of non-tangible assets in relation to other portfolios of non-tangible assets, detailed analysis of at least one portfolio of non-tangible assets to determine intellectual property parameters associated with said at least one portfolio of non-tangible assets.

In one embodiment, the present invention is a method and a system for using a computer to generate a numerical score for at least one non-tangible asset, wherein said numerical score indicates the relative value of said at least one non-tangible asset in relation to other non-tangible assets, comprising:

(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a numerical score based on intellectual property parameters using a least-squares algorithm;
   (i) wherein the numerical score indicates the relative value of said at least one non-tangible asset in relation to other non-tangible assets;
(d) store the numerical score in a database.

In a further embodiment, there is described a method and a system for using a computer to generate a numerical score for at least one non-tangible asset, wherein said at least one non-tangible asset is an asset other than a financial asset that lacks physical substance. Said at least one non-tangible asset comprises, without limitation, at least one of the following: a patent, a patent application, a copyrightable work or product, a trade secret, a deliverable, a published paper or technical report, or an invention disclosure.

In yet another embodiment, there is described a method and a system for using a computer to calculate a numerical score based on intellectual property parameters, wherein said numerical score indicates the relative value of said at least one non-tangible asset in relation to other non-tangible assets. Said relative value of said at least one non-tangible asset comprises, without limitation, at least one of the following: monetary worth, technical strength, licensing potential, breadth of applicability, present or future infringement potential, strategic merit.

In yet another embodiment, there is described a method and a system for using a computer to calculate a numerical score based on intellectual property parameters, wherein said intellectual property parameters comprise, without limitation, at least one of the following: number of other non-tangible assets by the same inventor(s), number of inventors of said at least one non-tangible asset, number of other non-tangible assets by the same assignee, number of assignments of said at least one non-tangible asset, number of claims of said at least one non-tangible asset, number of independent claims of said at least one non-tangible asset, number of dependent claims of said at least one non-tangible asset, number of words in a claim, number of keywords in a claim, number of family members of said at least one non-tangible asset, number of foreign counterparts of said at least one non-tangible asset, number of continuations, divisionals, or continuations-in-part of said at least one non-tangible asset, time in prosecution of said at least one non-tangible asset, time to expiration of said at least one non-tangible asset, maintenance status, number of citations of said at least one non-tangible asset, number of other non-tangible assets cited by said at least one non-tangible asset, number of other non-tangible assets cited by the examiner of said at least one non-tangible asset, number of other non-tangible assets cited by the inventor of said at least one non-tangible asset, number of other non-tangible assets that cite said at least one non-tangible asset, number of other non-tangible assets sharing the same patent class with said at least one non-tangible asset, number of other non-tangible assets sharing similar keywords with said at least one non-tangible asset, number of other non-tangible assets in a similar technical field to said at least one non-tangible asset.

In yet another embodiment, there is described a method and a system for using a computer to generate a numerical score for at least one non-tangible asset, wherein said numerical score indicates the relative value of said at least one non-tangible asset in relation to other non-tangible assets, comprising:

(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a numerical score based on intellectual property parameters using a least-squares algorithm;
   (i) wherein the numerical score indicates the relative value of said at least one non-tangible asset in relation to other non-tangible assets;
      (3) store the numerical score in a database;
      wherein the intellectual property parameters comprises the time in prosecution.

In yet another embodiment, there is described a method and a system for using a computer to generate a numerical score for at least one non-tangible asset, wherein said numerical score indicates the relative value of said at least one non-tangible asset in relation to other non-tangible assets, comprising:

(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters;
(c) calculate a numerical score based on intellectual property parameters using a least-squares algorithm;
   (i) wherein the numerical score indicates the relative value of said at least one non-tangible asset in relation to other non-tangible assets;
(d) store the numerical score in a database;
   wherein the intellectual property parameters comprises the number of litigations.

In a further embodiment, there is described a method and a system for using a computer to generate a numerical score, wherein the numerical score is further used to identify standards-essential patents among a set of patents and patent applications, or to rank standard-essential patents within a set of patents and patent applications. Said standard-essential patents, as would be known to one of ordinary skill in the art, mean patents that claim an invention that must be used to comply with a technical standard. For example, standard-essential patents include patents or patent applications that have been declared essential for the practice or implementation of a technical standard developed by standard setting organizations (SSOs) like the European Telecommunications Standards Institute (ETSI) or the Institute of Electrical and Electronic Engineers (IEEE).

In yet another embodiment, there is described a method and a system for using a computer to generate a numerical score for at least one non-tangible asset, wherein said at least one non-tangible asset which has a numerical score above a predetermined threshold is identified and an alert is communicated to the user. Said threshold can be an absolute number or a numerical figure relative to the known numerical scores of a subset of non-tangible assets.

In yet another embodiment, there is described a method for using a computer to calculate a numerical score based on intellectual property parameters, wherein intellectual property parameters comprise numerical scores of other non-tangible assets logically connected to said at least one non-tangible asset. Other non-tangible assets logically connected to said at least one non-tangible asset comprise, without limitation, at least one of the following: other non-tangible assets cited in said at least one non-tangible asset, other non-tangible assets that cite said at least one non-tangible asset, other non-tangible assets that share at least one inventor with said at least one non-tangible asset, other non-tangible assets with the same assignee of said at least one non-tangible asset, other non-tangible assets in the same patent classification subset of said at least one non-tangible asset, other non-tangible assets in the same technical field of said at least one non-tangible asset, or other non-tangible assets that share the same priority year with said at least one non-tangible asset.

In a further embodiment, there is described a method and a system for using a computer to generate a numerical score for at least one non-tangible asset, wherein said numerical score indicates the relative value of said at least one non-tangible asset in relation to other non-tangible assets, comprising:

(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a numerical score based on intellectual property parameters using a least-squares algorithm;
   (i) wherein the numerical score indicates the relative value of said at least one non-tangible asset in relation to other non-tangible assets;
(d) store the numerical score in a database;
   wherein the numerical score is generated at different instants in time. Said intellectual property parameters are often a function of time, and the calculations to generate a numerical score for said non-tangible asset can be repeated at different instants in time, generating numerical scores that can be equal or different. Said instants in time comprise, without limitation, different years, different months within the same year, or different stages of prosecution of said non-tangible asset. In yet a further embodiment, said numerical scores calculated at different instants in time can be used to calculate a marginal numerical score. Said marginal numerical score can be, without limitation, the difference of two numerical scores calculated at different instants in time.

In yet another embodiment, there is described a method and a system for using a computer to generate a numerical score for at least one non-tangible asset at different instants in time, wherein the numerical score is used iteratively as further input to strengthen the scoring system. For example, and without limitation, the numerical score generated at a previous instant in time could be used as an additional intellectual property parameter to iteratively calculate a set of numerical scores.

In yet a further embodiment, numerical scores of other non-tangible assets logically connected to said at least one non-tangible asset are also used iteratively as further input to strengthen the scoring system.

In a further embodiment, there is described a method and a system for using a computer to generate a numerical score for at least one non-tangible asset, wherein said numerical score indicates the relative value of said at least one non-tangible asset in relation to other non-tangible assets, comprising:

(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a numerical score based on intellectual property parameters using a least-squares algorithm;
   (i) wherein the numerical score indicates the relative value of said at least one non-tangible asset in relation to other non-tangible assets;
(d) store the numerical score in a database;
   wherein intellectual property parameters comprise numerical scores of seed non-tangible assets logically connected to said at least one non-tangible asset. Said seed non-tangible assets logically connected to said at least one non-tangible asset comprise, without limitation, at least one of the following: non-tangible assets with known numerical score that are logically connected to said at least one non-tangible asset, non-tangible assets that are logically connected to said at least one non-tangible asset for which numerical scores have been previously calculated, non-tangible assets that are logically connected to said at least one non-tangible asset for which the value is known a-priori.

In yet a further embodiment, there is described a method and a system for using a computer to generate a numerical score for at least one non-tangible asset, wherein said numerical score indicates the relative value of said at least one non-tangible asset in relation to other non-tangible assets, comprising:

(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a numerical score based on intellectual property parameters using a heuristic statistical algorithm based on probabilities;
   (i) wherein the numerical score indicates the relative value of said at least one non-tangible asset in relation to other non-tangible assets;
(d) store the numerical score in a database.

Said heuristic statistical algorithm based on probabilities comprises, without limitation, at least one of the following: linear regression algorithm, statistical analysis of a subset of non-tangible assets, probabilistic numerical score calculation based on numerical scores of other non-tangible assets, Markov-chain-based algorithm, time-series analysis. In yet another embodiment, numerical scores of other non-tangible assets logically connected to said at least one non-tangible asset are also used as parameters for said heuristic statistical algorithm based on probabilities.

In one prophetic example of said heuristic statistical algorithm, the numerical score of said at least one non-tangible asset is calculated as the product of a numerical score associated with other non-tangible assets citing said at least one non-tangible asset and a given probability figure, summed over all non-tangible assets citing said at least one non-tangible asset. Said probability figure represents, without limitation, the probability that the numerical score of a non-tangible asset citing said at least one non-tangible asset contributes to the numerical score of said at least one non-tangible asset. Said probability figure can be, without limitation, a number set a-priori, or calculated based on observations over known portfolios of non-tangible assets.

For example, consider an exemplary portfolio of non-tangible assets comprising non-tangible assets named P₁, P₂, P₃, P₄. Assume now that non-tangible assets P₂, P₃, P₄ cite non-tangible asset P₁, and further assume that numerical scores for non-tangible assets P₂, P₃, P₄ have been previously calculated and are, respectively, 0.9, 0.5 and 0.75. Assume now that the value of citing non-tangible assets contribute to the value of said at least one non-tangible asset with probability q. Then, the numerical score of P₁ can be calculated as:

Numerical Score(P₁)=q×0.9+q×0.5+q×0.75

In one prophetic example, assume q=0.5. Hence Numerical Score (P₁)=1.075. In a further prophetic example, assume q=0.75. Hence Numerical Score (P₁)=1.625. In yet another prophetic example, assume q=0.25. Hence Numerical Score (P₁)=0.5375. Probability q can be based on observations or set a-priori.

In further embodiment, there is described a method and a system for using a computer to generate a numerical score for at least one non-tangible asset, wherein said numerical score indicates the relative value of said at least one non-tangible asset in relation to other non-tangible assets, comprising:

(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a multi-dimensional numerical score based on intellectual property parameters using at least one of a least-squares algorithm and a heuristic statistical algorithm based on probabilities;
   (i) wherein the numerical score indicates the relative strength of said at least one non-tangible asset in relation to other non-tangible assets;
(d) store the numerical score in a database.

Said multi-dimensional numerical score indicates the relative value of said at least one non-tangible asset in relation to other non-tangible assets in a multi-dimensional numerical score space, wherein said multi-dimensional numerical score space comprises numerical scores calculated with different algorithms.

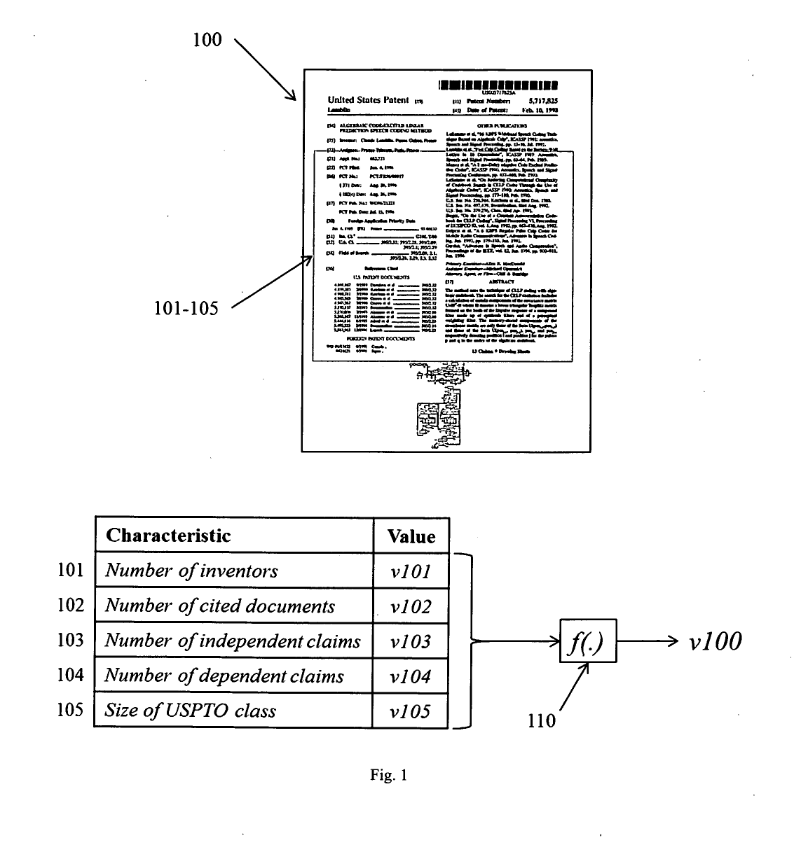

Referring now to one embodiment of the present invention in more detail, in FIG. 1 there is shown a list of intellectual property parameters 101-105 of at least one non-tangible asset 100, said intellectual property parameters contributing to the numerical score of said at least one non-tangible asset 100 itself.

In more detail, still referring to the invention of FIG. 1 said at least one non-tangible asset 100 as shown has a number of intellectual property parameters, including, without limitation, the number of inventors 101, the number of cited documents 102, the number of independent claims 103, the number of dependent claims 104, and the size of the US Patent and Trademark Office (USPTO) class 105.

In further detail, still referring to the invention of FIG. 1 different intellectual property parameters 101-105 of at least one non-tangible asset 100 are assigned numbers v101, v102, . . . , v105 and a numerical score associated with said at least one non-tangible asset 100 is calculated as a function ƒ(.) of, among other intellectual property parameters, said numbers v100=ƒ(v101, v102, v103, v104, v105).

The details of the invention as shown in FIG. 1 can change according to the at least one non-tangible asset being considered. Further, the number of intellectual property parameters 101-105 and the function ƒ(.) 110 can vary, without limitation, from one implementation to another. Function ƒ(.) 110 can be, without limitation, a linear or non-linear function of its input variables v101, v102, . . . , v105.

In even more detail, still referring to the invention of FIG. 1 a numerical score associated with said at least one non-tangible asset 100 is calculated as a function ƒ(.), where said function ƒ(.) can be, without limitation, a linear combination of said numbers v101, v102, . . . , v105, a least squares function of said numbers v101, v102, . . . , v105, or a weighted combination of said numbers v101, v102, . . . , v105.

The numerical score of said at least one non-tangible asset 100 can be evaluated on the basis of a number of intellectual property parameters associated with said at least one non-tangible asset 100. For example, the number of iterations between the inventor of a patent and the examiner could result in a high numerical score. Similarly, the absence of any foreign counterpart (or the abandonment of foreign applications) could result in a low numerical score.

The numerical score of said at least one non-tangible asset 100 is a function of a number of intellectual properties parameters, comprising, without limitation, the following:
v1. Patents by the same inventor (backward)
v2. Patents by the same inventor (forward)
v3. Number of inventors
v4. Patents with same assignee (backward)
v5. Patents with same assignee (forward)
v6. Assignee history (number of assignments)
v7. Patents with same keywords (backward)
v8. Patents with same keywords (forward)
v9. Number of independent claims
v10. Number of family members
v11. International to total family members ratio
v12. Number of continuations (forward)
v13. Number of continuations (backward)
v14. Time from file to granting
v15. Time to expiration
v16. Number of citations (forward)
v17. Number of citations (backward)
v18. Re-exam history (e.g. survival of re-exam)
v19. Maintenance status/timely payment of fees

The numerical score of said at least one non-tangible asset can be calculated, without limitation, as a weighted sum of the above characteristics:

$$\begin{matrix}v 100 = f ( v 1 , v 2 , v 3 , … ) {\sum }_{k = 1}^{L} {w}_{k} {v}_{k} \\ = {\underline{v}}^{T} \underline{w}\end{matrix}$$

where v=[v₁ v₂ . . . v_{L}]^{T} is a vector of said above sets of intellectual property parameters, and L is the number of said intellectual property parameters.
The vector

w=[w₂ w₂ . . . w_{L}]^{T}

represents a set of weights. Said set of weights can be, without limitation, set a-priori based on perceived relative importance of each intellectual property parameter, set from observations over at least one non-tangible asset or portfolio of non-tangible assets. In yet a further embodiment, said set of weights can be calculated, as would be evident to one of ordinary skill in the art, with a least-squares regression algorithm over intellectual property parameters of at least one seed non-tangible asset or portfolio of seed non-tangible assets.

In one prophetic example of the above algorithm, consider an exemplary portfolio of non-tangible assets comprising non-tangible assets named P₁, P₂, P₃, P₄. Assume now that the following intellectual property parameters associated with non-tangible assets P₁, P₂, P₃, P₄ have been retrieved and are as follows:

| | Intellectual property parameter | |
|---|---|---|
| Non-tangible asset | Number of citations | Time in prosecution (years) |
| P₁ | 5 | 1.8 |
| P₂ | 12 | 3.1 |
| P₃ | 8 | 3.3 |
| P₄ | 27 | 2.4 |

Then, the numerical score of said non-tangible assets P1, P2, P3, P4 can be calculated as:

S₁=Numerical Score(P₁)=w₁×Number of Citations(P₁)+w₂×Time in Prosecution(P₁)=w₁×5+w₂×1.8

S₂=Numerical Score(P₂)=w₁×Number of Citations(P₂)+w₂×Time in Prosecution(P₂)=w₁×12+w₂×3.1

S₃=Numerical Score(P₃)=w₁×Number of Citations(P₃)+w₂×Time in Prosecution(P₃)=w₁×8+w₂×3.3

S₄=Numerical Score(P₄)=w₁×Number of Citations(P₄)+w₂×Time in Prosecution(P₄)=w₁×27+w₂×2.4

In one specific prophetic example, weights w₁ and w₂ can be set a-priori as:

[w₁,w₂]=[1,1]

i.e., weighting both intellectual property parameters (namely, number of citations and time in prosecution) the same. Under such assumptions, the numerical scores of said non-tangible assets P₁, P₂, P₃, P₄ are:

S₁=1×5+1×1.8=6.8

S₂=1×12+1×3.1=15.1

S₃=1×8+1×3.3=11.3

S₄=1×27+1×2.4=29.4

In another specific prophetic example, weights w₁ and w₂ can be set a-priori as:

[w₁,w₂]=[1,2]

i.e., weighting time in prosecution twice as much as number of citations. Under such assumptions, the numerical scores of said non-tangible assets P₁, P₂, P₃, P₄ are:

S₁=1×5+2×1.8=8.6

S₂=1×12+2×3.1=18.2

S₃=1×8+2×3.3=14.6

S₄=1×27+2×2.4=31.8

In yet another specific prophetic example, weights w₁ and w₂ can be set a-priori as:

[w₁,w₂]=[2,1]

i.e., weighting number of citations twice as much as time in prosecution. Under such assumptions, the numerical scores of said non-tangible assets P₁, P₂, P₃, P₄ are:

S₁=2×5+1×1.8=11.8

S₂=2×12+1×3.1=27.1

S₃=2×8+1×3.3=19.3

S₄=2×27+1×2.4=56.4

Note that under all prophetic examples presented above, non-tangible asset P₄ receives the highest numerical score S₄, relative to numerical scores S₁, S₂, S₃ of other non-tangible assets P₁, P₂, P₃, P₄, respectively, under consideration.

In yet a further prophetic example, the set of weights w can be evaluated using a least-squares regression algorithm over at least one known seed non-tangible asset or portfolio of seed non-tangible assets.

Consider a subset of seed non-tangible assets, say, without any loss of generality, P₅, P₆, . . . , P_{T}, for which observed numerical scores have been associated numbers, for example and without limitation, between 0 and 100 (where 0 indicates the lowest assignable numerical score and 100 the highest assignable numerical score) by analyzing, without limitation, the technical and economic merit of each non-tangible asset. Observed numerical scores are denoted Ŝ₅, Ŝ₆, . . . , Ŝ_{T}.

As would be evident to one of ordinary skill in the art, a least-squares set of weights w can be defined, without limitation, as the vector that minimizes the square-error between the observed numerical scores Ŝⱼ and the calculated numerical scores Sⱼ, for j=1, 2, . . . , T, calculated using said set of weights.

Specifically:

$${\underline{w}}_{LS} = arg min \{ {\sum }_{j = 5}^{T} {\vert {S}_{j} - {\hat{S}}_{j} \vert}^{2} \}$$

or, in a vector notation:

w_{LS}=argmin∥S−Ŝ∥²

where

S=[S₅ S₆ . . . S_{T}]^{T}

and

Ŝ=[Ŝ₅ Ŝ₆ . . . Ŝ_{T}]^{T}

By calling

$$\underline{\underline{R}} = [ \begin{matrix}{ρ}_{15} & … & {ρ}_{L 5} \\ ⋮ & ⋱ & ⋮ \\ {ρ}_{1 T} & … & {ρ}_{LT}\end{matrix} ]$$

with L, as defined previously, the number of intellectual property parameters under consideration. We can set

S=Rw

Hence, the least square solution for w is:

w_{LS}=R⁺Ŝ

Where matrix R⁺ denotes the Moore-Penrose pseudo-inverse of matrix R defined as:

R⁺ [symbol] (R^{T}R)⁻¹R^{T}=R(RR^{T})⁻¹

In yet a further prophetic example of the above algorithm, consider an exemplary portfolio of seed non-tangible assets comprising non-tangible assets named P₅, P₆, P₇, P₈ for which observed numerical scores have been assigned numbers between, for example and without limitation, between 0 and 100 (where 0 indicates the lowest assignable numerical score and 100 the highest assignable numerical score) by analyzing, without limitation, the technical and economic merit of each non-tangible asset. Observed numerical scores are denoted Ŝ₅, Ŝ₆, Ŝ₇, Ŝ₈. Assume now that, in addition to said observed numerical scores, the following intellectual property parameters associated with non-tangible assets P₁, P₂, P₃, P₄ have been retrieved and are as follows:

| | Intellectual property parameter | | Observed |
|---|---|---|---|
| Non-tangible | Number of | Time in prosecution | numerical scores |
| asset | citations | (years) | Ŝⱼ |
| P₅ | 15 | 3.8 | 55 |
| P₆ | 33 | 4.1 | 90 |
| P₇ | 8 | 1.3 | 25 |
| P₈ | 27 | 1.4 | 60 |

Then, matrix R is defined as:

$$\underline{\underline{R}} = [ \begin{matrix}15 & 3.8 \\ 33 & 4.1 \\ 8 & 1.3 \\ 27 & 1.4\end{matrix} ]$$

And the vector

Ŝ=[55 90 25 60]^{T}

Based on the above prophetic assumptions, w_{LS} can be evaluated as:

$$\begin{matrix}{\underline{w}}_{LS} = \underline{\underline{R}} + \underline{\hat{S}} \\ = [ \begin{matrix}- 0.025 & 0.010 & - 0.002 & 0.039 \\ 0.280 & 0.045 & 0.052 & - 0.226\end{matrix} ] [ \begin{matrix}55 \\ 90 \\ 25 \\ 60\end{matrix} ] \\ = [ \begin{matrix}1.84 \\ 7.19\end{matrix} ]\end{matrix}$$

Such set of least-squares weights can be applied to the previous prophetic example to calculate numerical scores of exemplary portfolio of non-tangible assets comprising non-tangible assets P₁, P₂, P₃, P₄. More specifically:

S₁=1.84×5+7.19×1.8=22.14

S₂=1.84×12+7.19×3.1=44.37

S₃=1.84×8+7.19×3.3=38.45

S₄=1.84×27+7.19×2.4=66.94

In most cases, the analysis presented above will be applied to a subset of non-tangible assets defining a portfolio of non-tangible assets. Hence:

$${V}_{portfolio} {=}^{△} \frac{1}{M} {\sum }_{k ∈ θ}^{ } {V}_{k}$$

where θ is said subset of non-tangible assets defining said portfolio of non-tangible assets of cardinality M, and Vₖ is the numerical score of each non-tangible asset included in said portfolio of non-tangible assets.

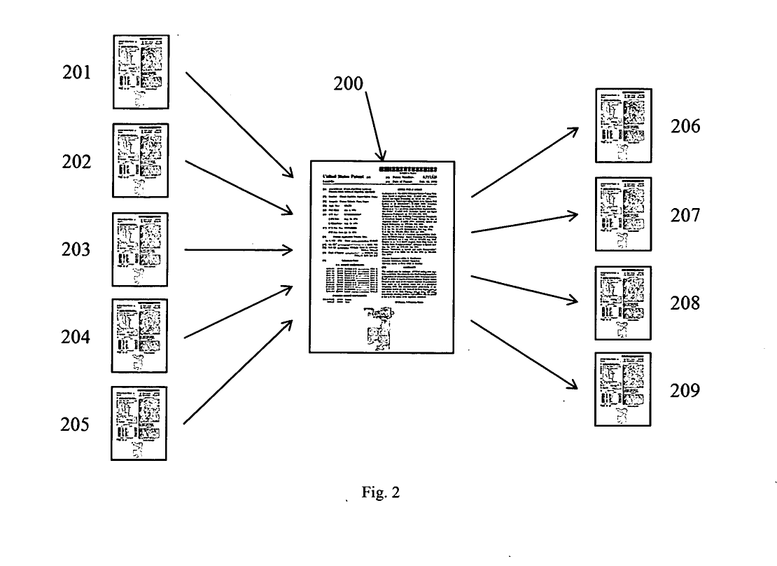

Referring now to another embodiment of the present invention shown in FIG. 2, there is shown a list of other non-tangible assets 201-209 logically connected to at least one non-tangible asset 200. For example, said other non-tangible assets 201-209 logically connected to said at least one non-tangible asset 200 could be, without limitation, backward and forward citations of said at least one non-tangible asset 200, wherein said citations contribute to the numerical score of said at least one non-tangible asset 200.

In more detail, still referring to the invention of FIG. 2 said at least one non-tangible asset 200 as shown has a number of citations, including, without limitation, backward citations 201-205 and forward citations 206-209. Citations can include, without limitation, other non-tangible assets, technical documents, technical standards specifications, invention disclosures, technical articles, etc.

In further detail, still referring to the invention of FIG. 2 different citations 201-209 are assigned numbers v201, v202, . . . , v209 and a numerical score associated with said at least one non-tangible asset 200 is calculated as a function ƒ(.) of, among other parameters, said numbers v200=ƒ(v201, v202, . . . , v209).

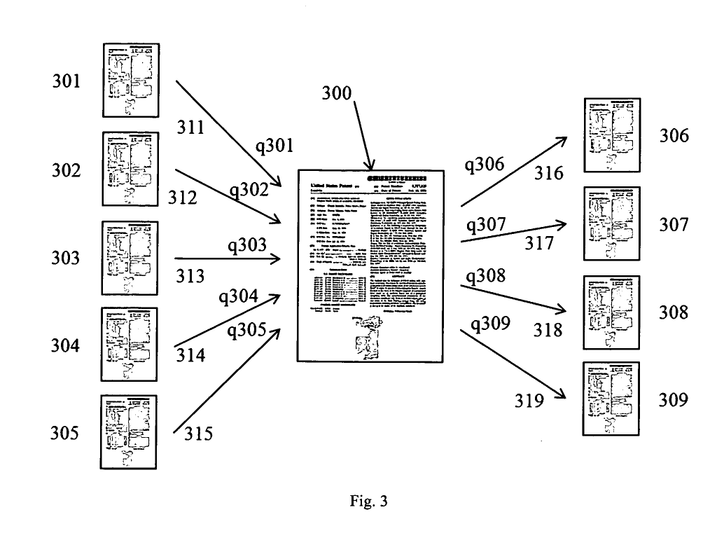

Referring now to yet another embodiment of the present invention shown in FIG. 3, there is shown a list of other non-tangible assets 301-309 logically connected to at least one non-tangible asset 300. For example, said other non-tangible assets 301-309 logically connected to said at least one non-tangible asset 300 could be, without limitation, backward and forward citations of said at least one non-tangible asset 300, wherein said citations contribute to the numerical score of said at least one non-tangible asset 300, said numerical score being calculated with a heuristic statistical algorithm based on probabilities.

Said heuristic statistical algorithm based on probabilities comprises, without limitation, at least one of the following: statistical analysis of a subset of non-tangible assets, probabilistic numerical score calculation based on numerical scores of other non-tangible assets, Markov-chain-based algorithm, time-series analysis.

In more detail, still referring to the invention of FIG. 3 said at least one non-tangible asset 300 as shown has a number of citations, including, without limitation, backward citations 301-305 and forward citations 306-309. Citations can include, without limitation, other non-tangible assets, technical documents, technical standards specifications, invention disclosures, technical articles, etc. Citations 301-309 are logically connected to said at least one non-tangible asset 300 through a network of links 311-319.

In further detail, still referring to the invention of FIG. 3 different citations 301-309 are assigned numbers v301, v302, . . . , v309. In addition, probabilities, q311, q312, . . . , q319, are associated with each of said links 311-319, such that a numerical score associated with said at least one non-tangible asset 300 is calculated as a function ƒ(.) of, among other intellectual property parameters, said numbers v300=ƒ(v301, v302, . . . , v309, q311, q312, . . . , q319).

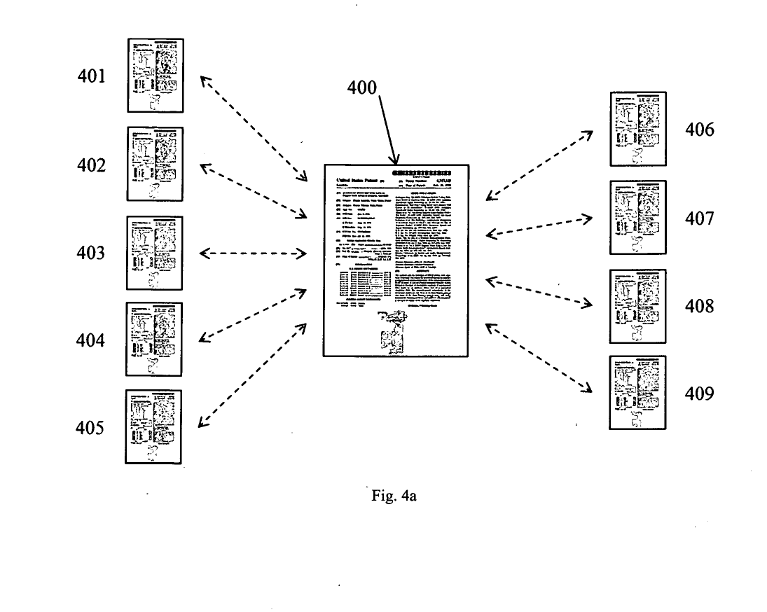

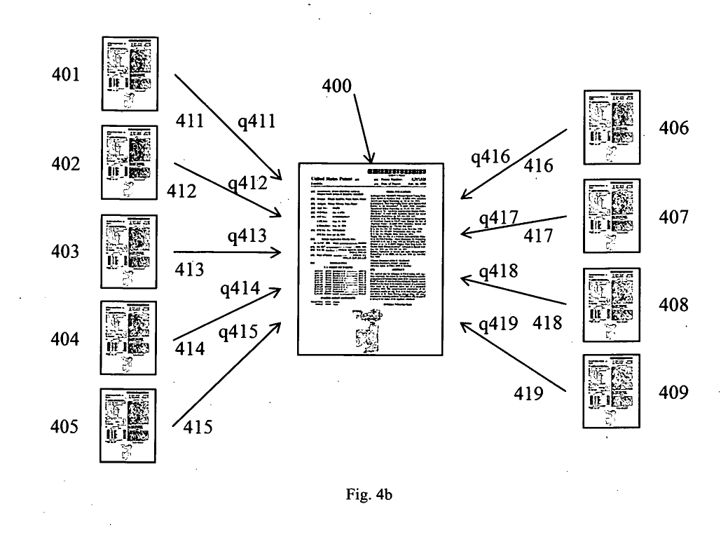

Referring now to yet another embodiment of the present invention shown in FIG. 4a, there is shown a list of seed non-tangible assets 401-409 logically connected to at least one non-tangible asset 400, said seed non-tangible assets contributing to the numerical score of said at least one non-tangible asset 400.

In more detail, still referring to the invention of FIG. 4a said at least one non-tangible asset 400 as shown is logically connected to a number of seed non-tangible assets, including, without limitation, seed non-tangible assets 401-405 filed in the same or adjacent USPTO class as said at least one non-tangible asset 400, and seed non-tangible assets 406-409 relating to a similar technical scope of said at least one non-tangible asset 400. Said seed non-tangible assets can include, without limitation, other non-tangible assets, technical documents, technical standards specifications, invention disclosures, technical articles, etc.

In further detail, still referring to the invention of FIG. 4a different seed non-tangible assets 401-409 are assigned a-priori numbers v401, v402, . . . , v409 and a numerical score associated with said at least one non-tangible asset 400 is calculated as a function ƒ(.) of, among other parameters, said numbers v400=ƒ(v401, v402, . . . , v409).

Referring now to yet another embodiment of the present invention shown in FIG. 4b, seed non-tangible assets 401-409 are logically connected to said at least one non-tangible asset 400 through a network of links 411-419, and probabilities, q411, q412, q419, are associated with each of said links 411-419, such that a numerical score associated with asset 400 is calculated as a function ƒ(.) of, among other parameters, said numbers v400=ƒ(v401, v402, . . . , v409, q411, q412, . . . , q419).

The numerical score of said at least one non-tangible asset 400 can be calculated using a heuristic statistical algorithm. For example, the numerical score of said at least one non-tangible asset 400 can be described statistically through the probability of said at least one non-tangible asset 400 to be “good” or “bad”.

For lack of better notation, said at least one non-tangible asset 400 will be referred to as P₁. Without concerning ourselves for the time being with what good and bad mean, one can define:

Pr[P₁=good]=Pr[P₁=1] [symbol] S₁

Clearly:

Pr[P₁=bad]=Pr[P₁=0]=1−Pr[P₁=1]=1−S₁

With the above definitions, one can also evaluate the following figures:

E[P₁]=1×Pr[P₁=1]+0×Pr[P₁=0]=S₁

Var[P₁]=E[P₁²]−E[P₁]²=1×Pr[P₁=1]+0×Pr[P₁=0]−S₁²=S₁−S₁²

Hence, S₁ measures the numerical score of P₁, while its variance estimates the risk associated with it.

If P₁ is at least one seed non-tangible asset, one can assume S₁ to be known. Consider now a non-tangible asset Pⱼ which cites P₁ (and assume, for simplicity, that P₁ is the only citation). P₁ is referred to as a backward citation of Pⱼ, while Pⱼ is a forward citation of P₁. Because of the citation, one can assume that Pⱼ “borrows” some characteristics from P₁. More specifically, the probability that Pⱼ is good is a function of S₁.

Let us call:

Sⱼ [symbol] Pr[Pⱼ=1].

A seed non-tangible asset is at least one non-tangible asset Pₖ for which Sₖ is known a-priori, and Sₖ=Pr[Pₖ=1]=1.

Consider a portfolio of non-tangible assets P₁, P₂, . . . , P_{N} logically connected through a network of citations, and assume, without any loss of generality, seed non-tangible assets are grouped and indexed such that Sₖ=1 for k=1, 2, . . . , M<N. We set Sⱼ [symbol] Pr[Pⱼ=1] for j=M+1, M+2, . . . , N, or, in vector notation, S=[S_{M+1}, S_{M+2}, . . . , S_{N}]^{T}.

One can show that S is the solution of a non-linear function of S itself and a matrix Q whose (h, k)-th element Qₕₖ is a function of the logical connection between Pₕ and Pₖ. Specifically, S is the solution of:

S=F(S,Q)

where F(•) is a function of S and Q that depends on the statistical/probabilistic model assumed, and, as would be known to one of ordinary skill in the art, can be generally solved with numerical methods.

In one further prophetic example of said heuristic statistical algorithm, the numerical score of said at least one non-tangible asset is calculated as the product of a numerical score associated with other non-tangible assets citing, or being cited by, said at least one non-tangible asset and a given probability figure, summed over all non-tangible assets citing, or being cited by, said at least one non-tangible asset. Said probability figure represents, without limitation, the probability that the numerical score of a non-tangible asset citing, or being cited by, said at least one non-tangible asset contributes to the numerical score of said at least one non-tangible asset. Said probability figure can be, without limitation, a number set a-priori, or calculated based on observations over known portfolios of non-tangible assets.

For example, consider an exemplary portfolio of non-tangible assets comprising non-tangible assets named P₁, P₂, P₃, P₄. Assume now that non-tangible assets P₂ and P₃ cite non-tangible asset P₁, while non-tangible assets P₃ and P₄ cite non-tangible asset P₂. Hence, P₁ is a backward citation for both P₂ and P₃, while P₂ and P₃ are forward citations of P₁. Moreover, P₂ is a backward citation for both P₃ and P₄, while P₃ and P₄ are forward citations of P₂.

One can represent the above citation network in a matrix format as follows:

$$\underline{\underline{\prod }} = [ \begin{matrix}0 & F & F & 0 \\ B & 0 & F & F \\ B & B & 0 & 0 \\ 0 & B & 0 & 0\end{matrix} ]$$

where the (k, h)-th element of Π, [Π]_{k,h}, equals B if Pₕ is a backward citation of Pₖ, F if Pₕ is a forward citation of Pₖ, and 0 otherwise (i.e., there is no logical connection between Pₕ and Pₖ).

Assume now that the numerical score of all citing non-tangible assets contribute to the numerical score of said cited-upon at least one non-tangible asset with probability q_{F}. Further assume that the numerical score of all non-tangible assets cited by said at least one non-tangible asset contribute to the numerical score of said at least one non-tangible asset with probability q_{B}. Probabilities q_{B} and q_{F} can be based on observations or set a-priori.

Then, the numerical score of Pⱼ can be calculated as:

$${S}_{j} = {\sum }_{k ∈ backward citations of j}^{ } {q}_{B} \times {S}_{k} + {\sum }_{k ∈ forward citations of j}^{ } {q}_{F} \times {S}_{k}$$

Using matrix Π and substituting it with a matrix Q accounting for said above probabilities q_{B} and q_{F}:

$$\underline{\underline{Q}} = [ \begin{matrix}0 & {q}_{F} & {q}_{F} & 0 \\ {q}_{B} & 0 & {q}_{F} & {q}_{F} \\ {q}_{B} & {q}_{B} & 0 & 0 \\ 0 & {q}_{B} & 0 & 0\end{matrix} ]$$

numerical scores can be calculated in vector format as:

$$\begin{matrix}\underline{S} = [ \begin{matrix}{S}_{1} \\ {S}_{2} \\ {S}_{3} \\ {S}_{4}\end{matrix} ] \\ = [ \begin{matrix}0 & {q}_{F} & {q}_{F} & 0 \\ {q}_{B} & 0 & {q}_{F} & {q}_{F} \\ {q}_{B} & {q}_{B} & 0 & 0 \\ 0 & {q}_{B} & 0 & 0\end{matrix} ] [ \begin{matrix}{S}_{1} \\ {S}_{2} \\ {S}_{3} \\ {S}_{4}\end{matrix} ] \\ = \underline{\underline{Q}} \underline{S}\end{matrix}$$

In another prophetic example, seed non-tangible assets can also be taken into account. For said seed non-tangible assets, the numerical scores are assumed, a-priori, to be 1. Hence, using the notation of the previous prophetic example, the numerical score of Pⱼ can be calculated as:

$${S}_{j} = {\sum }_{k ∈ backward citations of j}^{ } {q}_{B} \times {S}_{k} + {\sum }_{k ∈ forward citations of j}^{ } {q}_{F} \times {S}_{k} + {\sum }_{k ∈ backward seed citations of j}^{ } {q}_{B} + {\sum }_{k ∈ seed forward citations of j}^{ } {q}_{F}$$

In yet a further prophetic example of the above heuristic statistical algorithm, consider an exemplary portfolio of seed non-tangible assets comprising non-tangible assets named P₅, P₆, P₇, P₈. Also, in addition to the assumptions in the previous prophetic example, assume the following:
P₁ cites P₇ (hence, P₇ is a backward citation of P₁) and is cited by P₅ (hence, P₅ is a forward citation of P₁);
P₂ cites P₈ (hence, P₈ is a backward citation of P₁);
Both P₃ and P₄ cite P₅ and P₇ (hence, P₅ P₇ are backward citations of both P₃ and P₄), and are cited by P₈ (hence, P₈ is a forward citation of both P₃ and P₄).

In vector form, the above assumptions result in a system of equations for the numerical scores as follows:

$$\begin{matrix}\underline{S} = [ \begin{matrix}{S}_{1} \\ {S}_{2} \\ {S}_{3} \\ {S}_{4}\end{matrix} ] \\ = [ \begin{matrix}0 & {q}_{F} & {q}_{F} & 0 \\ {q}_{B} & 0 & {q}_{F} & {q}_{F} \\ {q}_{B} & {q}_{B} & 0 & 0 \\ 0 & {q}_{B} & 0 & 0\end{matrix} ] [ \begin{matrix}{S}_{1} \\ {S}_{2} \\ {S}_{3} \\ {S}_{4}\end{matrix} ] + [ \begin{matrix}{q}_{B} + {q}_{F} \\ {q}_{B} \\ 2 \times {q}_{B} + {q}_{F} \\ 2 \times {q}_{B} + {q}_{F}\end{matrix} ] \\ = \underline{\underline{Q}} \underline{S} + \underline{c}\end{matrix}$$

where c is defined as:

$$\underline{c} = [ \begin{matrix}{q}_{B} + {q}_{F} \\ {q}_{B} \\ 2 \times {q}_{B} + {q}_{F} \\ 2 \times {q}_{B} + {q}_{F}\end{matrix} ]$$

Hence, the above set of equations can be rewritten as follows:

[I−Q]S=c

where I is the identity matrix that matches the dimension of matrix Q. More specifically:

$$\underline{\underline{I}} = [ \begin{matrix}1 & 0 & 0 & 0 \\ 0 & 1 & 0 & 0 \\ 0 & 0 & 1 & 0 \\ 0 & 0 & 0 & 1\end{matrix} ]$$

Hence, a solution for the numerical scores is as follows:

S=[I−Q]⁻¹ c

Where [•]⁻¹, as would be known to one of ordinary skill in the art, indicates the inverse matrix operation.

In yet a further prophetic example, assume q_{F}=0.5 and q_{B}=0.2. Vector c and matrix Q become, respectively:

$$\underline{c} = [ \begin{matrix}0.7 \\ 0.2 \\ 0.9 \\ 0.9\end{matrix} ]$$

$$\underline{\underline{Q}} = [ \begin{matrix}0 & 0.5 & 0.5 & 0 \\ 0.2 & 0 & 0.5 & 0.5 \\ 0.2 & 0.2 & 0 & 0 \\ 0 & 0.2 & 0 & 0\end{matrix} ]$$

Then, the above set of equations in vector format defining numerical scores can be written as:

$$\begin{matrix}\underline{S} = [ \begin{matrix}{S}_{1} \\ {S}_{2} \\ {S}_{3} \\ {S}_{4}\end{matrix} ] \\ = {[ \begin{matrix}1 & - 0.5 & - 0.5 & 0 \\ - 0.2 & 1 & - 0.5 & - 0.5 \\ - 0.2 & - 0.2 & 1 & 0 \\ 0 & - 0.2 & 0 & 1\end{matrix} ]}^{- 1} \\ = [ \begin{matrix}0.7 \\ 0.2 \\ 0.9 \\ 0.9\end{matrix} ] \\ = [ \begin{matrix}1.48 & 1.11 & 1.30 & 0.56 \\ 0.56 & 1.67 & 1.11 & 0.83 \\ 0.41 & 0.56 & 1.48 & 0.28 \\ 0.11 & 0.33 & 0.22 & 1.17\end{matrix} ] [ \begin{matrix}0.7 \\ 0.2 \\ 0.9 \\ 0.9\end{matrix} ] \\ = [ \begin{matrix}2.93 \\ 2.47 \\ 1.98 \\ 1.39\end{matrix} ]\end{matrix}$$

In yet a further prophetic example, assume q_{F}=0.8 and q_{B}=0.1. Vector c and matrix Q become, respectively:

$$\underline{c} = [ \begin{matrix}0.9 \\ 0.1 \\ 1.0 \\ 1.0\end{matrix} ]$$

$$\underline{\underline{Q}} = [ \begin{matrix}0 & 0.8 & 0.8 & 0 \\ 0.1 & 0 & 0.8 & 0.8 \\ 0.1 & 0.1 & 0 & 0 \\ 0 & 0.1 & 0 & 0\end{matrix} ]$$

Then, the above set of equations in vector format defining numerical scores can be written as:

$$\begin{matrix}\underline{S} = [ \begin{matrix}{S}_{1} \\ {S}_{2} \\ {S}_{3} \\ {S}_{4}\end{matrix} ] \\ = {[ \begin{matrix}1 & - 0.8 & - 0.8 & 0 \\ - 0.1 & 1 & - 0.8 & - 0.8 \\ - 0.1 & - 0.1 & 1 & 0 \\ 0 & - 0.1 & 0 & 1\end{matrix} ]}^{- 1} \\ = [ \begin{matrix}0.7 \\ 0.2 \\ 0.9 \\ 0.9\end{matrix} ] \\ = [ \begin{matrix}1.37 & 1.43 & 2.24 & 1.15 \\ 0.29 & 1.50 & 1.43 & 1.20 \\ 0.17 & 0.29 & 1.37 & 0.23 \\ 0.03 & 0.15 & 0.14 & 1.12\end{matrix} ] [ \begin{matrix}0.9 \\ 0.1 \\ 1.0 \\ 1.0\end{matrix} ] \\ = [ \begin{matrix}4.76 \\ 3.04 \\ 1.78 \\ 1.30\end{matrix} ]\end{matrix}$$

While each non-tangible asset and logical connection thereof are different, it is assumed that, from a probabilistic point of view, non-tangible assets borrow from other logically connected non-tangible assets in a similar way. In particular, we define categories of logical connections that influence the numerical scores of non-tangible assets in the same (probabilistic) way, and probabilities associated with said categories of logical connections are set to the same value. Said categories of logical connections comprise, without limitation, at least one of the following: the number of other non-tangible assets that were cited by the examiner of said non-tangible assets, the number of other non-tangible assets that were cited by said non-tangible assets and resulted in amended claims.

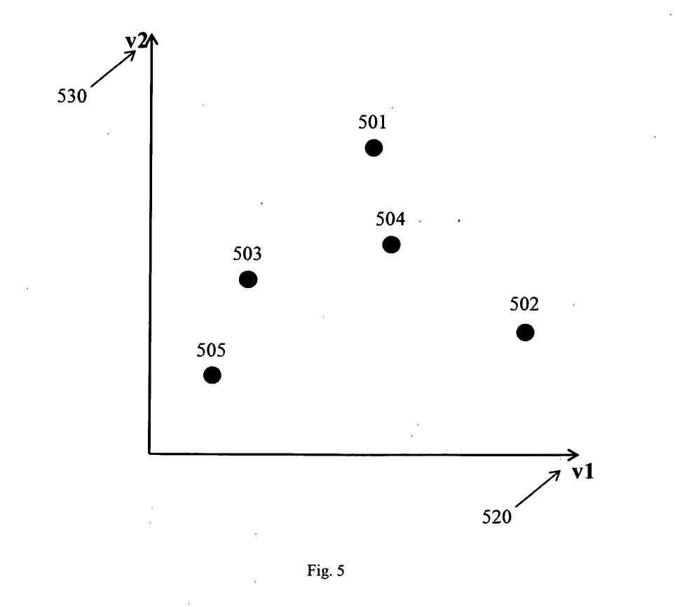

Referring now to yet another embodiment of the present invention shown in FIG. 5, there is shown a multi-dimensional representation of the value of a set of non-tangible assets 501-505 based on two numerical scores 510 and 520.

In more detail, still referring to the invention of FIG. 5 at least one non-tangible asset 501 as shown has a lower numerical score 510 than at least one different non-tangible asset 502 as shown, but higher than at least one further different non-tangible asset 503 as shown. On the other hand, said at least one non-tangible asset 501 has a higher numerical score 520 than at least one further different non-tangible asset 504 as shown and at least one further different non-tangible asset 505 as shown. Said at least one non-tangible asset 505 has both scores 510 and 520 lower than any other non-tangible assets 501-504.

In further detail, still referring to the invention of FIG. 5 numerical scores 510 and 520 could be, without limitation, at least one of the numerical scores obtained through any previously described method, or any other numerical score as applicable. Still referring to the invention of FIG. 5 and without limitation, the values of US patents 501-505 could be based on more than two numerical scores, and thus represented in a multi-dimensional space with more than two dimensions.

Any subset of non-tangible assets under consideration is not a static universe. In other words, new non-tangible assets are created every day. As new non-tangible asset appears, more logical connections—like backward and forward citations—are added to the system of equations describing the model.

More specifically, Sⱼ and N—where N is the number of non-tangible assets under consideration—are a function of time: Sⱼ(t) and N(t).

At a given instant in time t, the numerical score of at least one portfolio of non-tangible assets (wherein said at least one portfolio of non-tangible assets is a further subset of said subset non-tangible assets under consideration) is defined as:

$${\overline{S}}_{V} ( t ) {=}^{Δ} E [ V ] = \frac{1}{M} {\sum }_{k ∈ θ}^{ } {S}_{k} ( t )$$

The expected return of said subset of non-tangible assets under consideration is also defined as:

$${\overline{S}}_{TOT} ( t ) {=}^{Δ} E [ V ] = \frac{1}{N ( t )} {{\sum }^{N ( t )}}_{k ∈ θ}^{ } {S}_{k} ( t )$$

Therefore, a set of points in a two dimensional space can be formed:

A₁=( S̅_{V}(t₁), S̅_{TOT}(t₁)),A₂=( S̅_{V}(t₂), S̅_{TOT}(t₂)), . . . ,A_{now}=( S̅_{V}(t_{now}), S̅_{TOT}(t_{now})).

The coefficient β_{S} is defined as the slope of the linear regression corresponding to such points. When β_{S}≈1, the numerical score over time of said at least one portfolio of non-tangible assets is comparable to the numerical score of said subset of non-tangible assets under consideration. On the other hand, when β_{S}<1 (respectively, β_{S}>1), the numerical score over time of said at least one portfolio of non-tangible assets is lower (respectively, higher) than said subset of non-tangible assets under consideration.

At a given instant in time t, the risk of said at least one portfolio of non-tangible assets is defined as:

$${σ}_{V} ( t ) {=}^{Δ} \sqrt{E [ {V}^{2} ] - {E [ V ]}^{2}} = \frac{1}{M} \sqrt{{\sum }_{k ∈ θ}^{ } [ {S}_{k} ( t ) - {{S}_{k} ( t )}^{2} ]}$$

The risk of said subset of non-tangible assets under consideration is defined as:

$${σ}_{TOT} ( t ) {=}^{Δ} \frac{1}{N ( t )} \sqrt{{\sum }_{k = 1}^{N ( t )} [ {S}_{k} ( t ) - {{S}_{k} ( t )}^{2} ]}$$

Therefore, a set of points in a two dimensional space can be set:

B₁=(σ_{V}(t₁),σ_{TOT}(t₁)),B₂=(σ_{V}(t₂),σ_{TOT}(t₂)), . . . ,B_{now}=(σ_{V}(t_{now}),σ_{TOT}(t_{now})).

The coefficient β_{σ} is defined as the slope of the linear regression corresponding to such points. When β_{σ}≈1, the volatility of said at least one portfolio of non-tangible assets is comparable to the volatility of said subset of non-tangible assets under consideration. On the other hand, when β_{σ}<1 (respectively, β_{σ}>1), the volatility of said at least one portfolio of non-tangible assets is lower (respectively, higher) than the volatility of said subset of non-tangible assets under consideration.

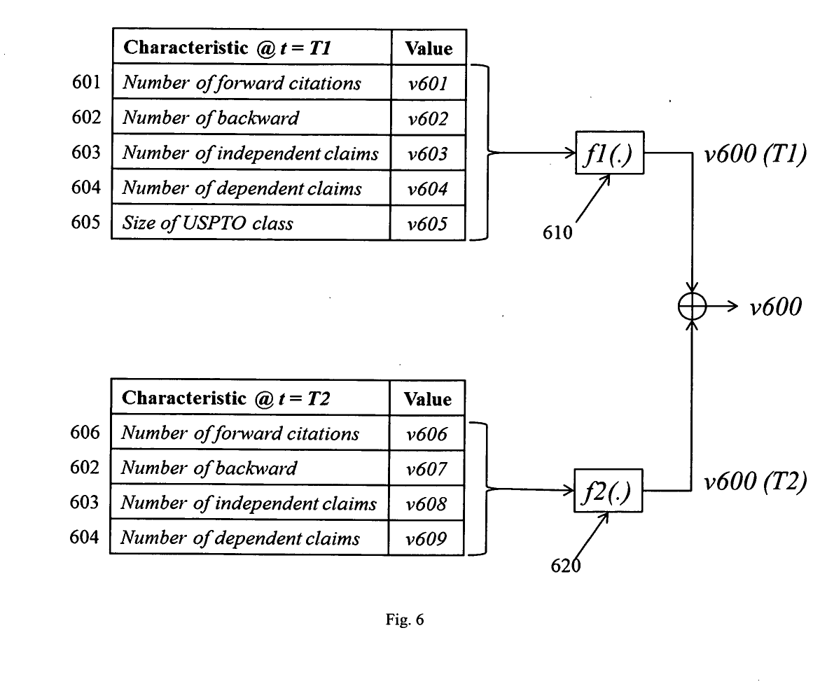

Referring now to yet another embodiment of the present invention shown in FIG. 6, there is shown a flow diagram to evaluate the numerical score of at least one non-tangible asset based on a numerical score calculated at two different instants in time.

In more detail, still referring to the invention of FIG. 6 at least one non-tangible asset 600 as shown has a number of intellectual property parameters 601-605 at time instant t=T1. For example, intellectual property parameter 601 represents the number of forward citations at time T1. Different intellectual property parameters 601-605 of said at least one non-tangible asset 600 at time t=T1 are assigned numbers v601, v602, . . . , v605 and a first numerical score associated with said at least one non-tangible asset 600 is calculated as a function ƒ1(.) 610 of, among other parameters, said numbers v600(T1)=ƒ1(v601, v602, v603, v604, v605).

Still referring to the invention of FIG. 6 said at least one non-tangible asset 600 as shown has a number of intellectual property parameters 606-609 at time instant t=T2 being, without limitation, subsequent to T1. For example, intellectual property parameter 606 represents the number of forward citations at time T2. Different intellectual property parameters 606-609 of said at least one non-tangible asset 600 at time t=T2 are assigned numbers v606, v607, . . . , v609 and a second numerical score associated with non-tangible asset 600 is calculated as a function ƒ2(.) 620 of, among other parameters, said numbers v600(T2)=ƒ2(v606, v607, v608, v609).

In further detail, still referring to the invention of FIG. 6 a marginal numerical score associated with said at least one non-tangible asset 600 is calculated as a the difference 630 between said first numerical score at time T1 and said second numerical score at time T2, respectively. More specifically, v600=v600(T2)−v600(T1)=ƒ2(v606, v607, v608, v609)−ƒ1(v601, v602, v603, v604, v605).

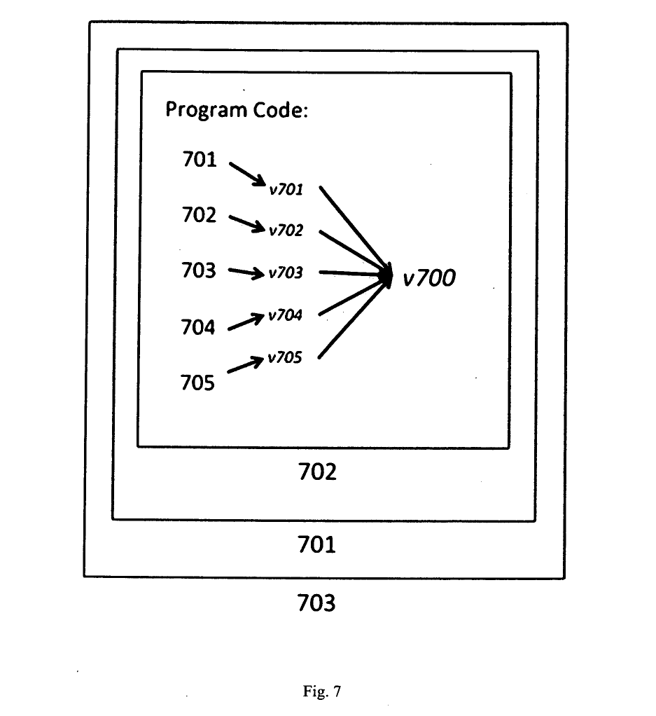

Referring now to yet another embodiment of the present invention shown in FIG. 7, there is shown a flow diagram representation of an apparatus for calculating the numerical score of at least one non-tangible asset 700.

In more detail, still referring to the invention of FIG. 7 there is provided a storage medium 701 for storing a program 702 of non-tangible asset valuation method while enabling the stored program 702 to be loaded into, and thus performed by, a computer 703 so as to obtain a numerical score v700 for at least one non-tangible asset 700.

In further detail, still referring to the invention of FIG. 7 different intellectual property parameters 701-705 of at least one non-tangible asset 700 are retrieved by a computer through the execution of said program 702, and numbers v701, v702, . . . , v705 are associated with said intellectual property parameters 701-705 and stored into said storage medium 701.

Still referring to the invention of FIG. 7 a numerical score v700 for non-tangible asset 700 is calculated by a computer through the execution of said program 702 and stored into said storage medium 701.

In broad embodiment, the present invention is a method and apparatus for valuating non-tangible assets.

The advantages of the present invention include, without limitation, the use of a set of highly relevant and related intellectual property parameters of at least one non-tangible asset to assert the value of said at least one non-tangible asset. Furthermore, the present invention makes use, without limitation, of logically connected non-tangible assets to assert the value of said at least one non-tangible asset. Furthermore, the present invention makes use, without limitation, of logically connected seed non-tangible assets to assert the value of said at least one non-tangible asset.

Those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method for using a computer to generate a numerical score for at least one non-tangible asset, wherein said numerical score indicates the relative value of said at least one non-tangible asset in relation to other non-tangible assets, comprising:
(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a numerical score based on intellectual property parameters using a least-squares algorithm;
(i) wherein the numerical score indicates the relative value of said at least one non-tangible asset in relation to other non-tangible assets;
(d) store the numerical score in a database.

2. A method according to claim 1, wherein the numerical score is calculated at different instants in time, and a marginal numerical score is calculated and stored in said database.

3. A method according to claim 1, wherein the intellectual property parameters comprise at least one of the following:
(1) the time in prosecution;
(2) the number of litigations;
(3) numerical scores of other non-tangible assets logically connected to said at least one non-tangible asset;
(4) numerical scores of seed non-tangible assets logically connected to said at least one non-tangible asset;
(5) the numerical score calculated at a previous instant in time.

4. A method according to claim 1, wherein the numerical score is further used to identify standards-essential patents.

5. A method according to claim 1, wherein the numerical score is further used to rank standards-essential patents.

6. A method according to claim 1, wherein further processing of the numerical score is performed, said further processing comprising at least one of the following:
(1) the numerical score stored in a database is made accessible via a network for additional data analysis
(2) identifying the at least one non-tangible asset when said numerical score is higher than a predetermined threshold, and communicating an alert to a user through a user interface; and
(3) outputting said numerical score on a device screen that comprises a user interface.

7. A method according to claim 1, wherein said intellectual property parameters are weighted by a set of weights, wherein said weights comprise any of the following:
(1) a set of a-priori numbers;
(2) a set of numbers derived from observations over at least one non-tangible asset or portfolio of non-tangible assets;
(3) a set of numbers calculated with a regression algorithm over at least one seed non-tangible asset or portfolio of seed non-tangible assets.

8. A method for using a computer to generate a numerical score for at least one non-tangible asset, wherein said numerical score indicates the relative value of said at least one non-tangible asset in relation to other non-tangible assets, comprising:
(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a numerical score based on intellectual property parameters using a heuristic statistical algorithm based on probabilities;
(i) wherein the numerical score indicates the relative value of said at least one non-tangible asset in relation to other non-tangible assets;
(d) store the numerical score in a database.

9. A method according to claim 8, wherein the numerical score is calculated at different instants in time, and a marginal numerical score is also calculated.

10. A method according to claim 8, wherein the intellectual property parameters comprise at least one of the following:
(1) the time in prosecution;
(2) the number of litigations;
(3) numerical scores of other non-tangible assets logically connected to said at least one non-tangible asset;
(4) numerical scores of seed non-tangible assets logically connected to said at least one non-tangible asset;
(5) the numerical score calculated at a previous instant in time.

11. A method according to claim 8, wherein the numerical score is further used to identify standards-essential patents.

12. A method according to claim 8, wherein the numerical score is further used to rank standards-essential patents.

13. A method according to claim 8, wherein further processing of the numerical score is performed, said further processing comprising at least one of the following:
(1) storing said numerical in a database further accessible via a network for additional data analysis
(2) identifying the at least one non-tangible asset when said numerical score is higher than a predetermined threshold, and communicating an alert to a user through a user interface;
(3) outputting said numerical score on a device screen that comprises a user interface.

14. A method according to claim 8, wherein said intellectual property parameters are weighted by a set of weights, wherein said weights comprise any of the following:
(1) a set of a-priori numbers;
(2) a set of numbers derived from observations over at least one non-tangible asset or portfolio of non-tangible assets;
(3) a set of numbers calculated with a regression algorithm over at least one seed non-tangible asset or portfolio of seed non-tangible assets.

15. A method for using a computer to generate a numerical score for at least one non-tangible asset, wherein said numerical score indicates the relative value of said at least one non-tangible asset in relation to other non-tangible assets, comprising:
(1) a memory device in communication with the computer; and
(2) a processor disposed in communication with the memory device, the processor configured to:
(a) receive a request to generate a numerical score for the at least one non-tangible asset based on intellectual property parameters;
(b) retrieve intellectual property parameters from the at least one non-tangible asset;
(c) calculate a multi-dimensional numerical score based on intellectual property parameters using at least one of a least-squares algorithm and a heuristic statistical algorithm based on probabilities;
(i) wherein the numerical score indicates the relative strength of said at least one non-tangible asset in relation to other non-tangible assets;
(d) store the numerical score in a database.

16. A method according to claim 15, wherein the numerical score is calculated at different instants in time, and a marginal numerical score is also calculated.

17. A method according to claim 15, wherein the intellectual property parameters comprise at least one of the following:
(1) the time in prosecution;
(2) the number of litigations;
(3) numerical scores of other non-tangible assets logically connected to said at least one non-tangible asset;
(4) numerical scores of seed non-tangible assets logically connected to said at least one non-tangible asset;
(5) the numerical score calculated at a previous instant in time.

18. A method according to claim 15, wherein the numerical score is further used to identify standards-essential patents.

19. A method according to claim 15, wherein the numerical score is further used to rank standards-essential patents.

20. A method according to claim 15, wherein further processing of the numerical score is performed, said further processing comprising at least one of the following:
(1) storing said numerical in a database further accessible via a network for additional data analysis
(2) identifying the at least one non-tangible asset when said numerical score is higher than a predetermined threshold, and communicating an alert to a user through a user interface;
(3) outputting said numerical score on a device screen that comprises a user interface.

21. A method according to claim 15, wherein said intellectual property parameters are weighted by a set of weights, wherein said weights comprise any of the following:
(1) a set of a-priori numbers;
(2) a set of numbers derived from observations over at least one non-tangible asset or portfolio of non-tangible assets;
(3) a set of numbers calculated with a regression algorithm over at least one seed non-tangible asset or portfolio of seed non-tangible assets.
